(19) United States
(12) Patent Application Publication
(10) Pub. No.: US 2016/0237888 A1
(43) Pub. Date: Aug. 18, 2016

(54) A SYSTEM OF PACKAGING OF FLUID AND ENERGY EXCHANGE ACCESSORIES IN A FLUID HANDLING MACHINE

(71) Applicant: Das Ajee KAMATH, PUNE (IN)

(72) Inventor: Das Ajee KAMATH, PUNE (IN)

(21) Appl. No.: 15/030,155

(22) PCT Filed: Oct. 20, 2014
(86) PCT No.: PCT/IN2014/000664

§ 371 Date: Apr. 18, 2016

(30) Foreign Application Priority Data
Oct. 18, 2013 (IN) 3277/MUM/2013

(51) Int. Cl. F02B 53/06; F02B 55/08; F02B 55/02; F02B 53/12; F02B 53/10

(52) U.S. Cl. CPC F02B 53/06; F02B 53/12; F02B 53/10; F02B 55/02; F02B 55/08

(57) ABSTRACT

A system of placement and packaging of fluid and energy exchange accessories in a fluid handling machine where the rotor that forms the moving link and stator that forms the fixed link and stator encases the rotor and the volume between rotor and stator are communicated with volume which is external to the encased volume for exchange of fluids and energy by fluid and energy exchange accessories that are fitted at predetermined points and fluid exchange accessories include intake-exhaust port, intake-exhaust valve and the energy exchange accessories include fluid injecting device, spark and energy addition device, energy removal device, and pressure relief valve, such that these exchange accessories and their actuators fitted on rotor and their actuation is timed by reference of rotor position with respect to stator or other rotor when multiple rotors are used and where the fluid and energy are transmitted through pathways within the rotor.

### TECHNICAL FIELD

The present invention relates to placement of fluid and energy exchange accessories in fluid handling machines, in particularly related to placement of intake, outlet valves, spark plugs, fuel injectors or the likes, in pumps, compressors, fluid and, fuel driven motors or the likes of such machines.

### BACKGROUND

In current generic fluid handing machines, the valves including intake and exhaust and spark ignition and heat addition devices are fitted into pockets made on the stator or casing which necessitates drilled holes on casing that punctures its inner surface which is exposed to the fluids handled inside the fluid handling machine, thereby causing various problems due to discontinuity of the stator surface hence hindering proper sealing of fluid as the rotor seals pass over the discontinuity. The seals at the extremity of the rotors that isolate spaces ahead and behind of rotor elements are unable to seal at puncture points and fluid bypasses across spaces supposedly to be isolated by the seals. This is a major cause of problems in rotary wankel engine. In vane type fluid handling machines, where circular piston rings are used, the ring peripheral surface bear against the inner surface of the stator. The piston ring edges bump against discontinuities and when such discontinuities are large enough and when the piston ring split ends open outwards at such discontinuities they get stuck within the punctures, seizing the pistons or ending up with broken piston rings. The rotary machines requires placing of intake and exhaust valves and at times it creates extreme temperature differential on the stator, as in wankel engines. This is due to segregated placement of valves and the heat zone not being smothered by fresh air intake during operational cycle as in conventional reciprocating I.C. Engines. The temperature differential creates differential expansions and distorts the geometry of machine components and hampers in appropriate combustion leading to difficulty in improving thermal efficiency and emissions. The puncture on stator body leads to stress concentration during load condition and require material reinforcement at areas of puncture, thus increasing material cost, manufacturing cost and making component design strenuous thus demanding in time, cost and resources.

It is therefore advantageous to provide an improved means to overcome the aforesaid problems, and these problems are solved in disclosed invention herein and also provides various other benefits and advantageous.

### SUMMARY OF THE INVENTION

Present invention discloses a system of packaging of fluid exchange accessories and energy exchange accessories in fluid handling machine where the rotor that forms the rotating or moving link of the kinematic chain and where the stator, that forms the fixed link, such that the stator encases the rotor and the volume between rotor and stator are communicated with an outside volume by means of said fluid exchange accessories and said energy exchange accessories fitted at predetermined points on said fluid handling machine, such that fluid and energy is exchanged between said volume and said outside volume during operation of said fluid handling machine, wherein the exchange is facilitated by said fluid exchange accessories and said energy exchange accessories constituting of fluid and energy addition and removal devices which includes any combination of intake, exhaust ports, intake and exhaust valve, fluid injecting device, spark and heat addition device and pressure relief valve, such that at least any one of said fluid exchange accessories and said energy exchange accessories are fitted on and are part of said rotor to keep the stator continuous to provide leak proof sealing, with fluid and energy transmitted through pathways within the rotor so that their actuation can be timed with respect to rotor position. The rotor constitutes of one or plurality of an individual constituent rotor such that the individual constituent rotor has relative motion with any of the individual constituent rotor along with the relative motion with the stator, where individual constituent rotor is fitted with at least any one or combination of intake or exhaust port, intake or exhaust valve, fluid injecting device or spark and heat addition device and pressure relief valve and can be timed with rotation of the individual rotor. The individual constituent rotor alternates between being fixed link and rotary link, wherein said individual constituent rotor has at least a vane such that the vane is fitted with at least any one or a combination of intake or exhaust port, intake or exhaust valve, fluid injecting device or spark and heat addition device and pressure relief valve. The vane has a first face and a second face, such that said first face is fitted with a first combination of at least any one or combination of said intake valve, said fluid injecting device, and spark and heat addition device and said second face is fitted with a second combination of at least any one of said exhaust valve and spark and heat addition device, such that volume enclosed between adjacent faces of said vanes has at least any one of the first combination and the second combination.

The Intake valve and the exhaust valve have opening and closing operations, which are carried out by an Actuator and timed by a Timing Device integrated into the Rotor. This Timing Device reads the Rotor position with respect to the Stator for actuation of the intake and the exhaust valve.

The Intake valve and the exhaust valve have opening and closing operations carried out by an Actuator and timed by a Timing Device integrated into the Rotor. This Timing Device reads the position of one of said Individual constituent Rotor with respect to another said Individual constituent Rotor for actuation of said Intake valve and the exhaust valve. At least any one of said Spark and Energy addition device, the fluid injection device and the energy removal device is operated by the Actuator and the operations is timed by the Timing Device. This Timing Device reads the position of said Rotor with respect to the Stator for actuation of either the Spark and Energy addition device or the fluid injection device or said energy removal device.

The Actuator operates Spark and Energy addition device or the fluid injection device or the energy removal device. And the Timing Device times these operations. This Timing Device reads the position of one of said Individual constituent Rotor with respect to another said Individual constituent Rotor for actuation of the Spark and Energy addition device or the fluid injection device and or energy removal device.

An Integrated Exchange accessory has the Spark and Energy addition device, the fluid injection device and the energy removal device integrated with any one of the Intake valve and the exhaust valve. The Integrated Exchange accessory is such that the Actuator of the integrated fluid exchange accessories and energy exchange accessories are integrated.

### BRIEF DESCRIPTION OF DRAWINGS

FIG. 1 illustrates an exemplary embodiment of the present invention depicting sectional view of complete assembly of the parts.

FIG. 2 illustrates an exemplary embodiment of the present invention depicting a sectional view of vane.

FIG. 3 illustrates an exemplary embodiment of the present invention depicting an isometric view of the individual constituent and the vane assembly.

FIG. 4 illustrates an exemplary embodiment of the present invention depicting an exploded view of vane along with fluid and energy exchange devices.

FIG. 5(a) illustrates an exemplary embodiment of the present invention depicting a front view of fluid and energy exchange devices.

FIG. 5(b) illustrates an exemplary embodiment of the present invention depicting a sectional view of fluid and energy exchange devices.

FIG. 5(c) illustrates an exemplary embodiment of the present invention depicting an isometric view of fluid and energy exchange devices.

FIG. 6(a) illustrates an exemplary embodiment of the present invention depicting an isometric view of spark and heat addition device.

FIG. 6(b) illustrates an exemplary embodiment of the present invention depicting a sectional view of spark and heat addition device.

| Description of Elements | Reference Numeral |
|---|---|
| Rotor | 10 |
| Individual constituent Rotor | 11 |
| First Volume | 12 |
| Stator | 14 |
| Holder ring | 17 |
| Intake-exhaust valve | 18 |
| Valve seat | 19 |
| Vane center | 21 |
| Spark and Energy addition device | 26 |
| Timing Device | 30 |
| Fluid exchange accessories | 36 |
| Energy exchange accessories | 37 |
| Pathways | 40 |
| Vane | 44 |
| First face | 46 |
| Second face | 48 |
| Actuator | 50 |
| Spark plug | 52 |
| Grounding Bush | 54 |
| Insulation | 56 |
| Integrated Exchange accessory | 58 |

### DETAILED DESCRIPTION OF INVENTION

The present invention can be fully understood by reading following detail description of the embodiments of a system of placement and packaging of fluid exchange accessories and energy exchange accessories in a fluid handling machine with a kinematic chain comprising of rotor (10), individual constituent rotor (11), stator (14), intake-exhaust valve (18), vane (44), spark and energy addition device (26) and the timing device (30).

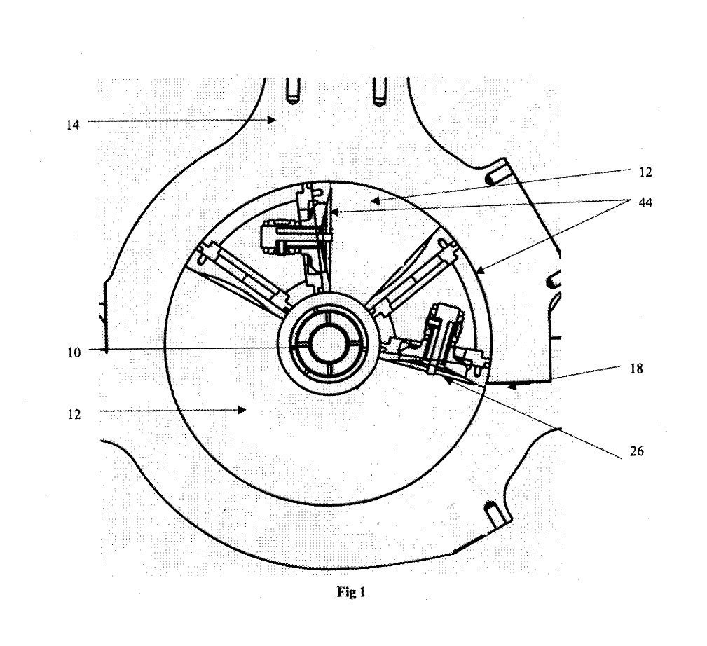

As shown in FIG. 1, a rotor (10) forms the rotating or moving link and a stator (14) forms the fixed link of the kinematic chain, such that the stator (14) encases the rotor (10). The volume entrapped between the rotor (10) and the stator (14) is the first volume (12) and is communicated with an outside volume by means of the fluid exchange accessories (36) and the energy exchange accessories (37) fitted at predetermined points on the fluid handling machine. During the operation of the fluid handling machine, fluid and energy are exchanged between the first volume (12) and the outside volume. The fluid exchange accessories (36) includes one or more intake-exhaust valve (18) working as either intake port or intake valve (18) or exhaust port or exhaust valve (18) for the exchange of fluids. Whereas the energy exchange accessories (37) comprises of fluid injecting device, energy removal device, pressure relief valve and spark and energy addition device such as a spark plug (52) fitted concentric with body of the valve.

The rotor (10) being the rotating part further comprises two individual constituent rotors (11). These individual constituent rotors (11) rotate with a relative motion between them and also with a relative motion between the stator (14) and rotor (10). The individual constituent rotors (11) alternate between a fixed link and rotary link during their operation. These individual constituent rotors (11) are provided with one or more vane (44), which contains the fluid and energy exchange accessories on their surfaces.

As shown in FIG. 2, the vane (44) has two surfaces opposing each other on which the fluid and energy exchange accessories are fitted on and thereby makes the fluid and energy exchange accessories a part of rotor (10). The two surfaces include a first face (46) and second face (48) for intake and exhaust of fluid respectively. The fluid from the fluid handling machine enters the first volume (12) being the volume between the vanes, through the intake valve or port on the first face (46). The exhaust of fluid takes place from the exhaust valve or port on the second face (48) of the vane (44). The actuator (50) controls the actuation of intake valve and exhaust valve, thereby controlling the fluid flow between first volume (12) and outside volume.

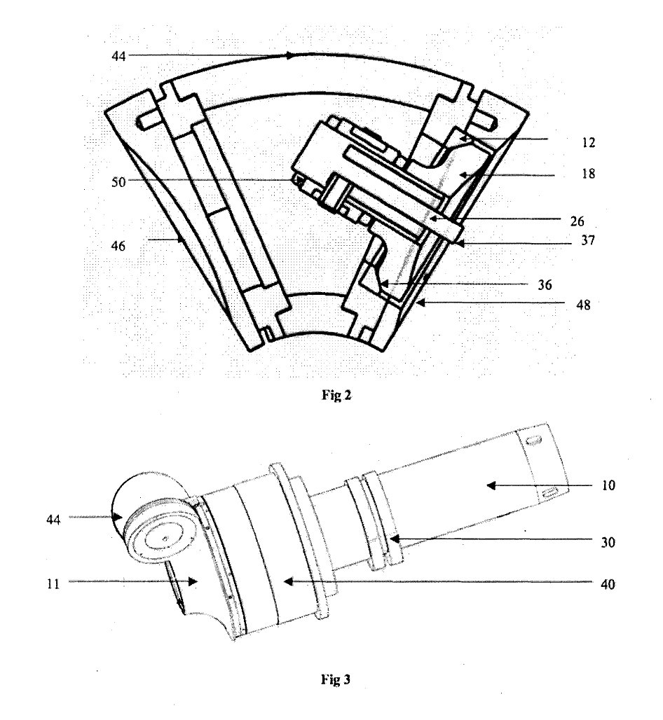

As shown in FIG. 3, the transmission of fluids to the first volume (12) takes place through the pathways (40) within the rotor (10). This pathways (40) also includes space inside vane center (21). The pathways (40) transmit the fluid to the first volume (12) through the intake valves (18) or ports, and similarly transmit the fluid from first volume (12) through the exhaust valve (18) or port. The actuation of the opening and closing of this intake and the exhaust valves is controlled by the actuator (50) and is timed by the timing device (30). This timing device (30) reads the position of the individual constituent rotor (11) with respect to the other or second individual constituent rotor (11) for the actuation of the intake-exhaust valve (18). The timing device (30) is integrated into the rotor (10).

As shown in FIG. 4, the encased space in the vane forms the vane center (21), which receives the fluid from the pathways (40). The Vane center (21) is connected to the Rotor (10) such that space inside vane center (21) is connected to the pathways (40) for the exchange of fluids through fluid exchange accessories. The surfaces of vane (44) i.e. first face (46) and the second face (48) is also fitted with the energy exchange accessories including the spark and energy addition device (26) i.e. a spark plug (52), fluid injection device and energy removal device is operated by the actuator (50) and is timed by the timing device (30). This timing device (30) reads the position of the individual constituent rotor (11) with respect to the other or second individual constituent rotor (11) for the actuation of the fluid injection device, energy removal device and the spark and energy addition device (26) i.e. a spark plug (52).

Further, the intake-exhaust valve (18) and valve seat (19) are designed to keep and maintain the proper sealing in the vane or in the rotor. And the holder ring (17) holds the fluid and energy exchange accessories like the inlet-exhaust valves (18) and the spark plug (52) together with vane center (21).

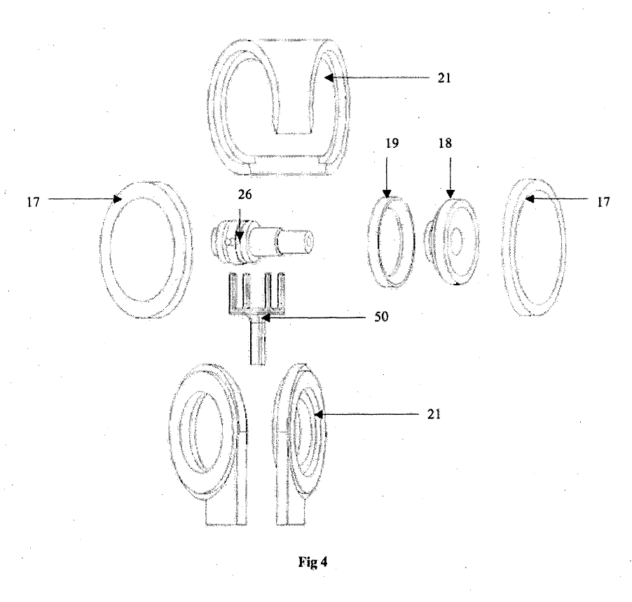

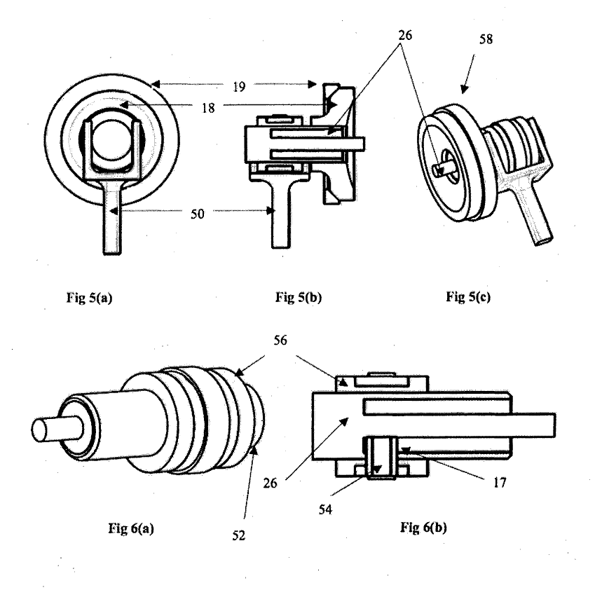

As shown in FIG. 5(a), FIG. 5(b) and FIG. 5(c), the actuator (50) is connected together with spark plug (52) and the inlet-exhaust valve (18) to form integrated exchange accessories (58) so that integrated exchange accessories (58) performs multiple functions of producing spark and intaking and exhausting of the working fluid. The integration of various fluid and energy exchange accessories in integrated exchange accessories results in the compact structure.

FIG. 6(a) and FIG. 6(b) shows the spark plug assembly as the energy exchange accessories in which the grounding bush (54) is separated from central metal rod by insulation (56) and forms a compact assembly.

In an alternate embodiment, the actuator (50) acts as holder for integrated exchange accessories (58) and actuates it. The actuator (50) also conducts the electric current to the grounding bush (54) to complete the circuit of spark plug.

In an alternate embodiment, the actuator (50) is connected together with spark plug (52) and either the inlet valve on first face (46) or the exhaust valve on the second face (48) to form integrated exchange accessories (58).

In an alternate embodiment, the fluid exchange accessories (36) and the energy exchange accessories (37) are fitted on and are part of the rotor (10), which acts as a rotating or a moving link. This fluid exchange accessories (36) as explained earlier includes one or more intake-exhaust valve (18) working as either intake port or intake valve (18) or exhaust port or exhaust valve (18). Whereas the energy exchange accessories (37) comprises of fluid injecting device, energy removal device and pressure relief valve and spark and energy addition device such as a spark plug (52).

In an alternate embodiment, the two individual constituent rotor (11) is mounted with one or more intake-exhaust valve (18) working as either intake port or intake valve (18) or exhaust port or exhaust valve (18) with a fluid injecting device, a spark plug (52), an energy removal device and a pressure relief valve.

In an alternate embodiment, the first face (46) of vane (44) is fitted with a first combination, which comprises of the intake valve (18), the fluid injecting device and spark plug (52) being the spark and energy addition device (26) for the exchange of fluid and energy. Similarly for an exhaust, the second face (48) is provided with a combination of at least any one of the exhaust valve (18), the energy removal device and spark and energy addition device (26). These first face (46) and second face (48) of the their respective vane (44) are such that, during the operation the first combination and the second combination performs together for the purpose of the exchange of fluid and energy between the first volume (12) and the outside volume.

In an alternate embodiment, the opening and closing of the intake valve and the exhaust valve is actuated by the actuator (50) and timed by the timing device integrated into the rotor (10). The timing device (30) reads the position of the rotor (10) with respect to the stator (14) for the actuation of the intake and exhaust valve.

In an alternate embodiment, the opening and closing of the intake valve and the exhaust valve is actuated by the actuator (50) and timed by the timing device (30) integrated into the rotor (10). The timing device reads the position of one of the Individual constituent rotor (11) with respect to another individual constituent rotor (11) for the actuation of the intake valve and exhaust valve.

In an alternate embodiment, the operation of the spark plug (52), the fluid injection device and energy removal device is actuated by the actuator (50) and is timed by the timing device (30). The timing device (30) reads the position of the rotor (10) with respect to the stator (14) and actuates any one of the spark plug (52), the fluid injection device and the energy removal device at desired events of time.

In an alternate embodiment, the spark and energy addition device (26), the fluid injection device and the energy removal device is placed with any one of the intake valve (18) or the exhaust valve (18) to form an integrated exchange accessory (58).

In an alternate embodiment the integrated exchange accessory (58) for fluid and integrated exchange accessory (58) for energy, have actuator (50) that is integrated so that working of both depends on each other.

I claim:

1. A system of placement and packaging of a fluid exchange accessories and an energy exchange accessories in a fluid handling machine comprising: a Rotor (10) that forms moving link of the kinematic chain of said fluid handling machine; a Stator (14) that forms the fixed link of said fluid handling machine, such that the Stator (14) encases the Rotor (10); and a First Volume (12) between said Rotor (10) and said Stator (14) are communicated with a second volume which is external to said First Volume (12) for exchange of fluids by means of said fluid exchange accessories, and said energy exchange accessories are fitted at predetermined points on said fluid handling machine for energy to be added and removed from said First Volume (12) during operation of said fluid handling machine, wherein said fluid exchange accessories include at least an intake port, at least an exhaust port, at least an Intake valve (18), at least an exhaust valve (18) and the energy exchange accessories that includes, at least a fluid injecting device, at least a Spark and Energy addition device (26), at least an energy removal device, and at least a pressure relief valve, such that at least any one of said fluid exchange accessories and said energy exchange accessories are fitted on and are part of said Rotor (10), with fluid and energy transmitted through Pathways (40) within the Rotor (10).

2. The system as claimed in claim 1, wherein said Rotor (10) constitutes of plurality of an Individual constituent Rotor (11) such that said Individual constituent Rotor (11) has relative motion with any of said Individual constituent Rotor (11), along with the relative motion with said Stator (14) and said Rotor (10), wherein said Individual constituent Rotor (11) is fitted with at least any one of at least an intake port, at least an exhaust port, at least an Intake valve (18), at least an exhaust valve (18), at least a fluid injecting device, at least a Spark and Energy addition device (26), at least an energy removal device and at least a pressure relief valve.

3. The system as claimed in claim 2, wherein said Individual constituent Rotor (11) alternates between being fixed link and rotary link during operation, wherein said Individual constituent Rotor (11) has at least a Vane (44) such that said Vane (44) is fitted with at least any one of at least an intake port, at least an exhaust port, at least an Intake valve (18), at least an exhaust valve (18), at least a fluid injecting device, at least a Spark and Energy addition device (26), at least an energy removal device and at least a pressure relief valve.

4. The system as claimed in claim 3, wherein said Vane (44) has a First face (46) and a Second face (48), such that said First face (46) is fitted with a first combination of at least any one of said Intake valve (18), said fluid injecting device, and Spark and Energy addition device (26) and said Second face (48) is fitted with a second combination of at least any one of said exhaust valve (18), said energy removal device and Spark and Energy addition device (26), such that volume enclosed between adjacent faces of said Vane (44) has at least any one of said first combination and said second combination.

5. The system as claimed in claim 4, wherein said Intake valve (18), and said exhaust valve (18) have opening and closing operations carried out by an Actuator (50) and timed by a Timing Device (30) integrated into said Rotor (10), wherein said Timing Device (30) reads said Rotor (10) position with respect to said Stator (14) for actuation of said intake valve and said exhaust valve (18).

6. The system as claimed in claim 2, wherein said Intake valve (18), and said exhaust valve (18) have opening and closing operations carried out by an Actuator (50) and timed by a Timing Device (30) integrated into said Rotor (10), wherein said Timing Device (30) reads the position of one of said Individual constituent Rotor (11) with respect to another said Individual constituent Rotor (11) for actuation of said Intake valve (18) and said exhaust valve (18).

7. The system as claimed in claim 5, wherein at least any one of said Spark and Energy addition device (26), said fluid injection device and said energy removal device is operated by said Actuator (50) and the operations is timed by said Timing Device (30), wherein said Timing Device (30) reads the position of said Rotor (10) with respect to said Stator (14) for actuation of said at least any one of said Spark and Energy addition device (26), said fluid injection device and said energy removal device.

8. The system as claimed in claim 6, wherein at least any one of said Spark and Energy addition device (26), said fluid injection device and said energy removal device is operated by said Actuator (50) and the operations is timed by said Timing Device (30), wherein said Timing Device (30) reads the position of one of said Individual constituent Rotor (11) with respect to another said Individual constituent Rotor (11) for actuation of at least any one of said Spark and Energy addition device (26), said fluid injection device and said energy removal device.

9. The system as claimed in claim 8, wherein an Integrated Exchange accessory (58) is used such that said Integrated Exchange accessory (58) has said Spark and Energy addition device (26), said fluid injection device and said energy removal device integrated with any one of said Intake valve (18) and said exhaust valve (18).

10. The system as claimed in claim 9, wherein said Integrated Exchange accessory (58) is such that the Actuator (50) of the integrated said fluid exchange accessories and said energy exchange accessories are integrated.
